(19) United States
(12) Patent Application Publication
(10) Pub. No.: US 2018/0345928 A1
(43) Pub. Date: Dec. 6, 2018

(54) Indefinite Stationary Braking Using Modulator Handoff Strategy

(71) Applicant: Bendix Commercial Vehicle Systems, LLC, Elyria, OH (US)

(72) Inventor: Nicholas A. BROYLES, Elyria, OH (US)

(21) Appl. No.: 15/614,690

(22) Filed: Jun. 6, 2017

(51) Int. Cl. B60T 8/40; B60T 8/48; B60T 8/32; B60T 7/12

(52) U.S. Cl. CPC B60T 8/40; B60T 7/12; B60T 8/326; B60T 8/4872

(57) ABSTRACT

A fluid brake system permitting a vehicle to remain in a stopped condition indefinitely includes a first fluid circuit by which fluid pressure is applicable to brake chambers of a first set of vehicle wheels, as well as a second fluid circuit by which fluid pressure is applicable to brake chambers of a second set of vehicle wheels. An electronic control unit or other such control device serves to repeatedly alternate fluid pressure application to the brake chambers of the first set of vehicle wheels, without fluid pressure application to the brake chambers of the second set of vehicle wheels, and fluid pressure application to the brake chambers of the second set of vehicle wheels, without fluid pressure application to the brake chambers of the first set of vehicle wheels.

### BACKGROUND OF THE INVENTION

### 1. Field of the Invention

A way to allow indefinite hold of fluid pressure at wheel ends using existing components of a vehicle braking system is provided.

### 2. Description of Related Art

U.S. Pat. No. 7,780,244 B2 to Inagaki et al. discloses a system utilizing recognition that keeping normally open control valves closed for hours for parking brake purposes is thermally disadvantageous, and proposes primary and secondary valve arrangements in which primary and secondary valves are electrically controlled for placement in half-opened states over extended terms due to changes in driving circuits and coil thermal capacity. Other documents of interest are U.S. Pat. No. 4,568,131 to Blomberg et al., U.S. Pat. No. 6,305,759 B1 to Ho et al., U.S. Pat. No. 6,386,649 B1 to Ross, U.S. Pat. No. 6,741,922 B2 to Holler, U.S. Pat. No. 8,494,745 B2 to Schneider et al., U.S. Pat. No. 8,857,787 B2 to Zula, U.S. Pat. No. 8,869,831 B2 to Haehn et al., U.S. Pat. No. 8,938,346 B2 to Oliveira et al., U.S. Pat. No. 9,031,754 B2 to Matoy et al., Chinese Publication 104097621 A to Foitzik et al. (or its U.S. equivalent, U.S. Patent Application Publication 2014/0306514 A1), U.S. Patent Application Publication 2007/0046098 A1 to Grolle et al., U.S. Patent Application Publication 2011/0233993 A1 to Sakai, and Japanese Publication 2002-178901 to Araki, identifying as its applicant Daihatsu Motor Co. Ltd. Certain additional background information is available from a pair of Bendix Service Data publications, BENDIX WINGMAN ACB (Active Cruise with Braking), SD-13-3333, published May 2012, and BENDIX ESP EC-80 Controller, SD-13-4986, published July 2015.

### SUMMARY OF THE INVENTION

Advanced driver assistance systems are now required to bring a vehicle to a stop. The duration over which the vehicle must remain stopped may be indefinite. Currently, modulators (i.e. modulator valves or traction valves) used in vehicle braking should only be activated for brief periods of time to prevent thermal damage. Accordingly, one object of the present invention is to provide a simple process for permitting indefinite pressure control of a stopped vehicle. The present invention proposes a way to allow indefinite hold of fluid pressure via modulators by handing off which modulators are active. This operation involves changing activation of front and rear circuits to hold the system in a parked state, and no structural changes are necessary to existing modulator valves. A control strategy for switching off modulators to ensure that no one modulator is in a hold state for longer than is necessary, allowing essentially indefinite pressure control of a stopped vehicle, is realized accordingly.

According to one preferred embodiment, a fluid brake system permitting a vehicle to remain in a stopped condition indefinitely includes a first fluid circuit by which fluid pressure is applicable to brake chambers of a first set of vehicle wheels, as well as a second fluid circuit by which fluid pressure is applicable to brake chambers of a second set of vehicle wheels. An electronic control unit or other such control device is provided to repeatedly alternate fluid pressure application to the brake chambers of the first set of vehicle wheels, without fluid pressure application to the brake chambers of the second set of vehicle wheels, and fluid pressure application to the brake chambers of the second set of vehicle wheels, without fluid pressure application to the brake chambers of the first set of vehicle wheels. In one configuration, the first and second fluid circuits include respective pressure modulator valves providing the fluid pressure application to the brake chambers of the first and second vehicle wheel sets, while in another configuration, the fluid circuits include respective traction valves providing the fluid pressure application to the brake chambers of the vehicle wheel sets.

To assure the vehicle remains stationary, fluid pressure application to the brake chambers of the first set of vehicle wheels and the fluid pressure application to the brake chambers of the second set of vehicle wheels overlap by a predetermined period of time. According to the arrangements particularly described here, this predetermined period of overlap lasts 1-2 seconds, while the fluid pressure application to the brake chambers of the first and second sets of vehicle wheels occurs for periods of 150 seconds or less. The first set of vehicle wheels, for example, may include vehicle drive wheels, while the second set of vehicle wheels may include vehicle steer wheels. An overall vehicle operation process is also described.

### BRIEF DESCRIPTION OF THE DRAWINGS

FIG. 1 is a view schematically illustrating elements of an existing fluid brake system and associated elements of a vehicle incorporating that fluid brake system with which the handoff strategy according to the present invention is usable.

FIG. 2 is a view illustrating circuit actuation timing according to the present invention.

FIG. 3 is a view schematically showing electrical interconnection of certain elements included in FIG. 1 with an electronic control unit (ECU) used to operate those elements.

### DETAILED DESCRIPTION OF THE INVENTION

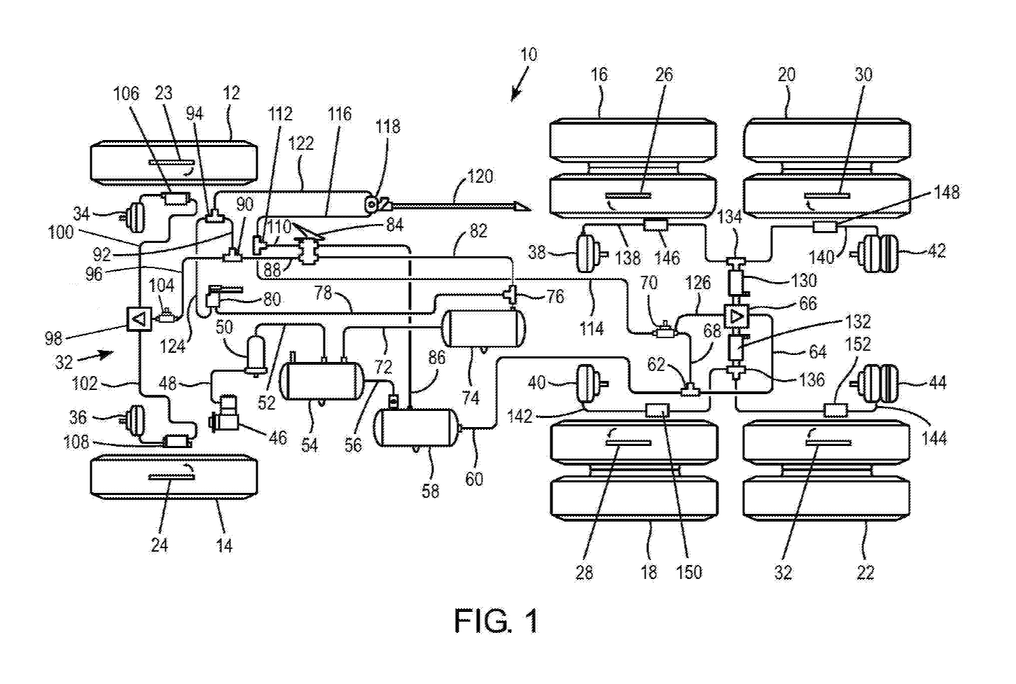

FIG. 1 illustrates certain elements of an existing fluid brake system and associated elements of a vehicle incorporating that fluid brake system with which the handoff strategy according to the present invention is usable. While the particular brake system shown is a pneumatically operated system, it is to be understood that the invention is not limited in application only to pneumatic systems, but is applicable as well to systems relying on other sorts of operating fluids, such as hydraulically operated brake systems. The vehicle 10 shown in FIG. 1 includes a right steer wheel 12, a left steer wheel 14, a right drive wheel or wheel set (hereafter referred to “wheel” for simplicity) 16, a left drive wheel or wheel set (hereafter referred to as “wheel” for simplicity) 18, a right additional wheel or wheel set (hereafter referred to as “wheel” for simplicity) 20, and a left additional wheel or wheel set (again, hereafter referred to as “wheel” for simplicity) 22. Axle mounted speed sensors 23, 24, 26, 28, 30, and 32 respectively associated with the right steer wheel 12, the left steer wheel 14, the right drive wheel 16, the left drive wheel 18, the right additional wheel 20, and the left additional wheel 22 are utilized in a known manner to detect wheel slip or wheel lock-up during braking operations.

The particular fluid brake system 32 for the vehicle 10 shown in FIG. 1 includes a brake chamber 34 to actuate a brake associated with the right steer wheel 12, a brake chamber 36 to actuate a brake associated with the left steer wheel 14, a brake chamber 38 to actuate a brake associated with the right drive wheel 16, a brake chamber 40 to actuate a brake associated with the left drive wheel 18, a brake chamber and spring brake arrangement 42 associated with the right additional wheel 20, and a brake chamber and spring brake arrangement 44 associated with the left additional wheel 22. Air is taken into the fluid brake system 32 by way of a compressor 46, operated in a known manner, e.g. by way of a vehicle engine or electrically, passed via a fluid line 48 to a dehumidifier 50, and from the dehumidifier 50 through a fluid line 52 to a supply reservoir 54.

A primary circuit fluid supply line 56 connects the supply reservoir 54 to a rear axle service reservoir 58, which, in turn, is connected by a fluid line 60 to the inlet of an appropriate valve 62, such as a double check valve, having a pair of outlets. One outlet of the valve 62 is interconnected by a fluid line 64 to a relay valve 66, while the other outlet of the valve 62 is interconnected by a fluid line 68 to a drive axle traction control valve 70. As explained by way of example in the Haehn et al. (831) patent mentioned above, the entire disclosure of which is incorporated herein by reference as non-essential material, traction control valves such as the valve 70 normally operate to provide controlled delivery of fluid to service brakes in traction control situations, such as when an excessive torque for given road conditions is commanded by a vehicle operator. The drive axle traction control valve 70 is in fluid communication with the relay valve 66 by way of a line 126.

A secondary circuit fluid supply line 72 connects the supply reservoir 54 to a front axle service reservoir 74, which, in turn, is connected to the inlet of an appropriate valve 76, such as a double check valve, having a pair of outlets. One outlet of the valve 76 is connected by a fluid line 78 to a trailer control valve 80, while the other outlet of the valve 76 is connected by a fluid line 82 to a pedal operated service brake valve 84. The rear axle service reservoir 58 is also connected by way of a fluid line 86 to the pedal operated service brake valve 84. In another example, the first circuit could be connected diagonally, i.e. with a front right wheel plus a rear left wheel connected, and the second circuit could be connected oppositely diagonally, i.e. with a front left wheel plus a rear right wheel connected.

A fluid line 88 interconnects the front axle service reservoir 74, by way of the pedal operated service brake valve 84, to the inlet of an appropriate valve 90, such as a double check valve, having a pair of outlets. One outlet of the valve 90 is connected by a fluid line 92 to an inlet of another appropriate valve 94, while a fluid line 96 interconnects the other outlet of the valve 90 to a steer axle traction control valve 104, similar to the valve 70, leading to a relay valve 98, similar to the valve 66. Fluid is directed from the relay valve 98 both through a fluid line 100 towards the brake chamber 34 associated with the right steer wheel 12 and through a fluid line 102 towards the brake chamber 36 associated with the left steer wheel 14. The steer axle traction control valve 104 operates similarly to the drive axle traction control valve 70 mentioned previously. A right steer axle pressure modulator valve 106 is interposed in the fluid line 100 between the relay valve 98 and the brake chamber 34 associated with the wheel 12, while a left steer axle pressure modulator valve 108 is similarly interposed in the fluid line 102 between the relay valve 98 and the brake chamber 36 associated with the wheel 14. As the Haehn et al. (831) patent mentioned above notes, modulator valves such as the valves 106 and 108 normally control the delivery of fluid pressure to and the exhaust of fluid pressure from respective brake chambers, in this case, the chambers 34 and 36. The Ho et al. (759) and Ross (649) patents mentioned above, the entire disclosures of which are incorporated herein by reference as non-essential material, supply concrete examples of pressure modulator valve structures and operation. Drive axle modulator valves 146 and 150 and additional axle modulator valves 148 and 152, described below, normally operate in the same way as the steer axle pressure modulator valves 106 and 108 to control delivery of fluid pressure to and exhaust of fluid pressure from their respective brake chambers.

An outlet of the pedal operated service brake valve 84 communicates fluid supplied through the line 86 from the rear axle service reservoir 58, via a fluid line 110, to the inlet of an appropriate valve 112, such as a double check valve, having a pair of outlets. One outlet of the valve 112 passes fluid through the line 114 to the drive axle traction control valve 70, while the other outlet of the valve 112 passes fluid through a line 116 leading to a connector 118 for a trailer supply/service line 120. An outlet of the valve 94 similarly communicates via a line 122 with the connector 118 such that, with appropriate operation of the trailer control valve 80, fluid from the front axle service reservoir 74 can pass through the lines 78 and 124, through the valve 94, and to the line 122. As mentioned previously, another outlet of the pedal operated service brake valve 84 communicates fluid supplied from the front axle service reservoir 74 through the line 82, via the line 88, to the valve 90. From the valve 90, fluid passes by way of the fluid line 96 past the traction control valve 104 and the relay valve 98 towards the brake chambers 34 and 36 associated with the steer wheels 12 and 14.

Fluid provided from the rear axle service reservoir 58 through the fluid lines 60 and 64 and/or through the fluid line 86, the service brake valve 84, and the fluid lines 110, 114, and 126 to the relay valve 66 is transmitted, through valves 130 and 132, respectively, to connectors 134 and 136, which feed that fluid to lines 138, 140, 142, and 144. Lines 138 and 140 respectively communicate the connector 134 to the brake chamber 38 and the brake chamber of the arrangement 42, while lines 142 and 144 respectively communicate the connector 136 to the brake chamber 40 and the brake chamber of the arrangement 44. In the fluid line 138, a right drive axle pressure modulator valve 146 is interposed between the connector 134 and the brake chamber 38 associated with the right drive wheel 16, and in the fluid line 140, a right additional axle pressure modulator valve 148 is interposed between the connector 134 and the brake chamber of the arrangement 42 associated with the right additional wheel 20. Similarly, in the fluid line 142, a left drive axle pressure modulator valve 150 is interposed between the connector 136 and the brake chamber 40 associated with the left drive wheel 18, and in the fluid line 144, a left additional axle pressure modulator valve 152 is interposed between the connector 136 and the brake chamber of the arrangement 44 associated with the left additional wheel 22.

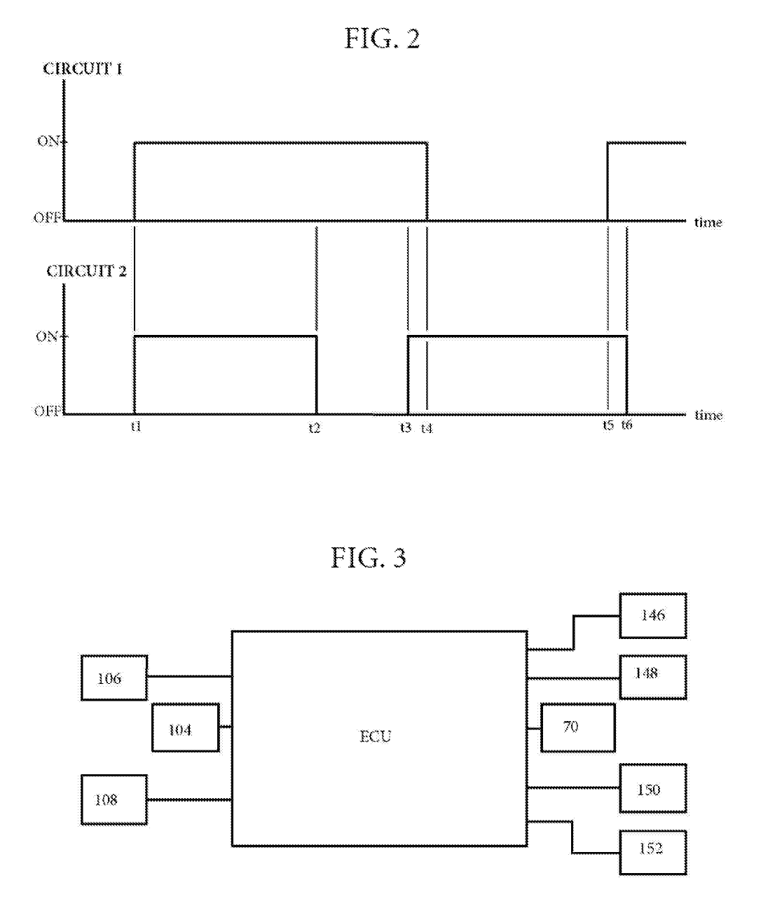

The present invention is contemplated as particularly useful in a situation in which the vehicle 10 shown in FIG. 1 comes to a stop using pressure provided by all of the brake chambers 34, 36, 38, and 40, as well as the brake chambers associated with the arrangements 42 and 44, and is then to be immobilized for an extended period of time. Once the vehicle comes to a stop with pressure in all wheel ends, regardless of whether it is a driver applied pressure or an autonomous supplied pressure, it is possible to indefinitely keep fluid pressure in the chambers 34, 36, 38, and 40, and the brake chambers associated with the arrangements 42 and 44 as well, by handing off, with the ECU represented in FIG. 3, which modulators are active. During this handing off procedure, the ECU represented in FIG. 3 selectively energizes and de-energizes solenoids constituting parts of the pressure modulator valves 106, 108, 146, 148, 150, and 152. In particular, the ECU causes the solenoids of either the pressure modulator valves 146, 148, 150, and 152, constituting part of a primary fluid circuit identified in FIG. 2 as CIRCUIT 1, or the solenoids of the pressure modulator valves 106 and 108, constituting part of a secondary fluid circuit identified in FIG. 2 as CIRCUIT 2, to be energized, rendering alternative sets of the brake chambers effective to apply continued pressure. The primary fluid circuit, CIRCUIT 1, mentioned may be characterized as a rear circuit, which includes the brake chamber 38, the brake chamber 40, and the brake chambers associated with arrangements 42 and 44, the modulator valves 146, 148, 150, and 152, and other fluid supply components shown in FIG. 1 associated with the right drive wheel 16, the left drive wheel 18, the right additional wheel 20, and the left additional wheel 22. The secondary fluid circuit, CIRCUIT 2, mentioned, on the other hand, may be characterized as a front circuit, which includes the brake chambers 34 and 36, the modulator valves 106 and 108, and other fluid supply components shown in FIG. 1 associated with the right steer wheel 12 and the left steer wheel 14, but which may possibly include fluid supply components (not shown) associated with the fluid brake system 32 shown in FIG. 1 by way of the connector 118 and the trailer supply/service line 120. One difference from an ABS (anti-lock braking system) is that this system removes air from an entire circuit during operation of the alternating application.

Referring now to FIG. 2, one possible operation sequence for the arrangements represented in FIGS. 1 and 3 will be described. During a period of time leading up to a time t1, the vehicle 10 is brought to a stop using fluid pressure in the chambers 34, 36, 38, and 40, as well as the chambers associated with the arrangements 42 and 44. Beginning at the time t1, the ECU shown in FIG. 3 actuates the solenoids constituting parts of all of the pressure modulator valves 106, 108, 146, 148, 150, and 152 to keep brake application in effect at all wheels 12, 14, 16, 18, 20, and 22. At a time t2, the ECU de-actuates the solenoids of the pressure modulator valves 106, 108 associated with the brake chambers 34 and 36 forming parts of the secondary fluid circuit CIRCUIT 2, thereby releasing brake application pressure at the wheels 12 and 14, while keeping the pressure modulator valves 146, 148, 150, and 152 forming parts of the primary fluid circuit CIRCUIT 1 actuated, maintaining brake application pressure at the wheels 16, 18, 20, and 22.

At a time t3, the ECU represented in FIG. 3 actuates the previously de-actuated solenoids of the CIRCUIT 2 pressure modulated valves 106, 108 to renew brake application pressure at the wheels 12 and 14, and then, at a time t4, de-actuates the solenoids of the CIRCUIT 1 pressure modulated valves 146, 148, 150, and 152, thereby releasing brake application pressure at the wheels 16, 18, 20, and 22. In a similar manner, at a time t5, the ECU actuates the previously de-actuated solenoids of the CIRCUIT 1 pressure modulated valves 146, 148, 150, and 152 to renew brake application pressure at the wheels 16, 18, 20, and 22, and then at a time t6, de-actuates the solenoids of the CIRCUIT 2 pressure modulated valves 106 and 108 to release brake application pressure at the right and left steer wheels 12 and 14. Brake actuation pressure in at least one of the fluid circuits, CIRCUIT 1 and CIRCUIT 2, is thus maintained at all times. This hand off procedure can be continued as necessary for an essentially unlimited duration.

By way of example only, it is contemplated that once the vehicle 10 is brought to a stop either by an operator or automatically at a time t1, the actual CIRCUIT 1 application interval from t1 to t4 could be a predetermined time, from about 30 seconds up to approximately 150 seconds, the CIRCUIT 1 to CIRCUIT 2 handoff interval from t3 to t4 would be between 1 and 2 seconds, the CIRCUIT 2 application interval from t3 to t6, again, could be the same predetermined time, from about 30 seconds up to approximately 150 seconds, and the CIRCUIT 2 to CIRCUIT 1 handoff interval from t5 to t6, again, would be between 1 and 2 seconds, with this cycle being repeated indefinitely. However, each circuit could be applied for different predetermined times.

When modulator valves are deenergized, they allow pressure pass through. As one modification to the procedure discussed above, instead of controlling the pressure modulator valves 106, 108, 146, 148, 150, and 152 individually as described, the traction control valves could be employed to provide transition. Transition in this case conceivably could be accomplished while removing modulator valve action entirely, e.g. by using the ECU shown in FIG. 3 to produce operation of the traction control valves 70 and 104 rather than the modulator valves, alternating full pressure application to the CIRCUIT 1 elements/no pressure application to the CIRCUIT 2 elements with full pressure application to the CIRCUIT 2 elements/no pressure application to the CIRCUIT 1 elements.

If, at any time during the routine, motion of the vehicle is detected (e.g. by wheel speed sensors), the routine will be discontinued, and pressure in response to the original deceleration request will be applied to all circuits.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A fluid brake system permitting a vehicle to remain in a stopped condition indefinitely, comprising:
a first fluid circuit by which fluid pressure is applicable to brake chambers of a first set of vehicle wheels, and a second fluid circuit by which fluid pressure is applicable to brake chambers of a second set of vehicle wheels,
wherein fluid pressure application to the brake chambers of the first set of vehicle wheels without fluid pressure application to the brake chambers of the second set of vehicle wheels is repeatedly alternated with fluid pressure application to the brake chambers of the second set of vehicle wheels without fluid pressure application to the brake chambers of the first set of vehicle wheels.

2. The fluid brake system of claim 1, wherein the first fluid circuit includes pressure modulator valves providing the fluid pressure application to the brake chambers of the first set of vehicle wheels.

3. The fluid brake system of claim 2, wherein the pressure modulator valves are first pressure modulator valves, and wherein the second fluid circuit includes second pressure modulator valves providing the fluid pressure application to the brake chambers of the second set of vehicle wheels.

4. The fluid brake system of claim 1, wherein the first fluid circuit includes a traction valve providing the fluid pressure application to the brake chambers of the first set of vehicle wheels.

5. The fluid brake system of claim 4, wherein the traction valve is a first traction valve, and wherein the second fluid circuit includes a second traction valve providing the fluid pressure application to the brake chambers of the second set of vehicle wheels.

6. The fluid brake system of claim 1, wherein the fluid pressure application to the brake chambers of the first set of vehicle wheels and the fluid pressure application to the brake chambers of the second set of vehicle wheels overlap by a predetermined period of time after an initial stop produced by the first and second fluid circuits.

7. The fluid brake system of claim 6, wherein the predetermined period of time is 1-2 seconds.

8. The fluid brake system of claim 6, wherein the fluid pressure application to the brake chambers of the first set of vehicle wheels occurs for a second predetermined period of time.

9. The fluid brake system of claim 8, wherein the fluid pressure application to the brake chambers of the second set of vehicle wheels occurs for a third predetermined time period, which is different than the second predetermined time period.

10. The fluid brake system of claim 1, wherein the first set of vehicle wheels includes vehicle drive wheels.

11. The fluid brake system of claim 10, wherein the second set of vehicle wheels includes vehicle steer wheels.

12. The fluid brake system of claim 1, wherein the vehicle is placed into the stopped condition autonomously by way of a driver assistance system.

13. A vehicle operation process comprising:
bringing a vehicle to a stop with pressure in brake chambers of first and second sets of vehicle wheels, and
repeatedly alternating application of fluid pressure with a first fluid circuit to the brake chambers of the first set of vehicle wheels without fluid pressure application to the brake chambers of the second set of vehicle wheels and application of fluid pressure application with a second fluid circuit to the brake chambers of the second set of vehicle wheels without fluid pressure application to the brake chambers of the first set of vehicle wheels to permit the vehicle to remain in a stopped condition indefinitely.

14. The vehicle operation process of claim 13, wherein the first fluid circuit includes pressure modulator valves providing the fluid pressure application to the brake chambers of the first set of vehicle wheels.

15. The vehicle operation process of claim 14, wherein the pressure modulator valves are first pressure modulator valves, and wherein the second fluid circuit includes second pressure modulator valves providing the fluid pressure application to the brake chambers of the second set of vehicle wheels.

16. The vehicle operation process of claim 13, wherein the first fluid circuit includes a traction valve providing the fluid pressure application to the brake chambers of the first set of vehicle wheels.

17. The vehicle operation process of claim 16, wherein the traction valve is a first traction valve, and wherein the second fluid circuit includes a second traction valve providing the fluid pressure application to the brake chambers of the second set of vehicle wheels.

18. The vehicle operation process of claim 13, wherein the fluid pressure application to the brake chambers of the first set of vehicle wheels and the fluid pressure application to the brake chambers of the second set of vehicle wheels overlap by a predetermined period of time.

19. The vehicle operation process of claim 18, wherein the predetermined period of time is 1-2 seconds.

20. The vehicle operation process of claim 13, wherein the fluid pressure application to the brake chambers of the first set of vehicle wheels occurs for a period of 150 seconds or less.

21. The vehicle operation process of claim 20, wherein the fluid pressure application to the brake chambers of the second set of vehicle wheels also occurs for a period of 150 seconds or less.

22. An electronic control unit configured to operate a vehicle brought to a stop with pressure in brake chambers of first and second sets of vehicle wheels by repeatedly alternating application of fluid pressure with a first fluid circuit to the brake chambers of the first set of vehicle wheels without fluid pressure application to the brake chambers of the second set of vehicle wheels and application of fluid pressure application with a second fluid circuit to the brake chambers of the second set of vehicle wheels without fluid pressure application to the brake chambers of the first set of vehicle wheels to permit the vehicle to remain in a stopped condition indefinitely.

23. The electronic control unit of claim 22, wherein the first fluid circuit includes pressure modulator valves providing the fluid pressure application to the brake chambers of the first set of vehicle wheels.

24. The electronic control unit of claim 23, wherein the pressure modulator valves are first pressure modulator valves, and wherein the second fluid circuit includes second pressure modulator valves providing the fluid pressure application to the brake chambers of the second set of vehicle wheels.

25. The electronic control unit of claim 22, wherein the first fluid circuit includes a traction valve providing the fluid pressure application to the brake chambers of the first set of vehicle wheels.

26. The electronic control unit of claim 25, wherein the traction valve is a first traction valve, and wherein the second fluid circuit includes a second traction valve providing the fluid pressure application to the brake chambers of the second set of vehicle wheels.

27. The electronic control unit of claim 22, wherein the fluid pressure application to the brake chambers of the first set of vehicle wheels and the fluid pressure application to the brake chambers of the second set of vehicle wheels overlap by a predetermined period of time.

28. The electronic control unit of claim 27, wherein the predetermined period of time is 1-2 seconds.

29. The electronic control unit of claim 22, wherein the fluid pressure application to the brake chambers of the first set of vehicle wheels occurs for a period of 150 seconds or less.
